(19) United States
(12) Patent Application Publication
(10) Pub. No.: US 2014/0297373 A1
(43) Pub. Date: Oct. 2, 2014

(54) PRUNING OF VALUE DRIVER TREES

(71) Applicant: INTERNATIONAL BUSINESS MACHINES CORPORATION, Armonk, NY (US)

(72) Inventors: Rama Akkiraju, Cupertino, CA (US); Ruoyi Zhou, San Jose, CA (US)

(73) Assignee: International Business Machines Corporation, Armonk, NY (US)

(21) Appl. No.: 13/853,549

(22) Filed: Mar. 29, 2013

(51) Int. Cl. G06Q 10/06

(52) U.S. Cl. CPC G06Q 10/06395
USPC 705/7.41

(57) ABSTRACT

A method includes obtaining a value driver tree including (i) one or more parent metrics determined to be of interest to a party and (ii) one or more child metrics. The one or more parent metrics are used to measure at least one of a value of a company, an organization, a service provider, a service consumer or an individual. The one or more child metrics are used to determine the value of the one or more parent metrics. The method includes performing a statistical analysis on historical metrics data of the one or more parent metrics and the one or more child metrics. The method includes pruning the value driver tree based on the statistical analysis by altering the position of the one or more child metrics relative to the one or more parent metrics.

### BACKGROUND

The present disclosure relates to pruning value driver trees, and in particular to performing a statistical analysis of historical data of metrics and adjusting the metrics in a value driver tree according to the statistical analysis.

Value Driver Trees offer a systematic framework for organizing and analyzing factors that influence the key performance indicators of a company or of a strategic situation to be analyzed. A value driver is a variable or a determinant that influences the value of a company or the value of a performance metric that is to be analyzed. Often, many factors, big and small, influence the key performance indicators of a company. For a Value Driver Tree to be a useful tool for analysis, it is important to capture those that have the greatest impact on value so that management can derive critical insights about areas of underperformance, priorities, investment decisions, and action plans. Value Driver Trees are typically modeled as a directed network. This formal representation mechanism allows for capturing the correlation relationships among metrics. This enables simulation analysis thereby enabling decision makers to predict the outcomes as a function of the underlying measures in the network. A typical example value driver tree has ‘share holder value’ at the root of the tree. The root is then expanded to capture the drivers of share holder value, namely, revenues, costs, and capital efficiencies. Each sub node in the tree is then further expanded by elaborating on the operational levers that influence the parent nodes. While this is the most common instance of a Value Driver Tree, the root of a value driver tree can begin at any level and go down as many levels as it is necessary to derive the insights needed for a specific strategic situation.

In transactions in which goods or services are exchanged between a provider and a consumer, the consumer may request bids from providers for providing the goods or services. Many factors determine the value of an offering to both the provider and the consumer. For example, providers and consumers may wish to be able to determine a value of an offering to both the provider and the consumer, an extent to which the offering adheres to providers' processes, meets the consumer's expectations, a likelihood that the offering can be completed as offered by the provider, and many other factors affecting the value of the offering. Value driver trees can be used to assess the value that a good or a service offers to a consumer from either a provider or consumer perspective.

### SUMMARY

Embodiments include a method including obtaining a value driver tree including (i) one or more parent metrics determined to be of interest to a party and (ii) one or more child metrics. The one or more parent metrics are used to measure at least one of a value of a company, an organization, a service provider, a service consumer or an individual. The one or more child metrics are used to determine the value of the one or more parent metrics. The method includes performing a statistical analysis on historical metrics data of the one or more parent metrics and the one or more child metrics. The method includes pruning the value driver tree based on the statistical analysis by altering the position of the one or more child metrics relative to the one or more parent metrics.

Further embodiments include an apparatus for pruning a value driver tree. The apparatus includes memory configured to store a value driver tree including one or more parent metrics determined to be of value to a party and one or more child metrics associated with the one or more parent metrics, and configured to store historical metrics data. The apparatus includes a processor configured to perform a statistical analysis on the value driver tree based on the historical metrics data, and configured to prune the value driver tree based on the statistical analysis by altering a relationship on the value driver tree of the one or more child metrics to the one or more parent metrics to generate a refined value drive tree.

Further embodiments include a computer program product for pruning a value driver tree. The computer program product includes a tangible storage medium readable by a processing circuit and configured to store instructions for execution by the processing circuit for performing a method. The method includes obtaining a value driver tree including one or more parent metrics and one or more child metrics, the one or more parent metrics determined to be of value to a party, and the one or more child metrics assumed by a provider of the one or more child metrics to relate to the one or more parent metrics. The method also includes performing a statistical analysis on historical metrics data of the one or more child metrics. The method also includes pruning the value driver tree based on the statistical analysis by altering a position relative to the one or more parent metrics of the one or more child metrics.

Further embodiments include a method. The method includes pruning a value driver tree (VDT) to generate a pruned VDT, where pruning the VDT includes performing at least one of (i) omitting a first metric of the VDT from the pruned VDT and (ii) changing a dependency of the first metric from a second metric in the pruned VDT based on conducting a statistical analysis on historical metrics data of each metric of the VDT. The method includes using the pruned VDT to assess the quality of a service provided by a company, an organization, a service provider, a service consumer and/or an individual.

Additional features and advantages are realized through the techniques of the present disclosure. Other embodiments and aspects of the present disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

The subject matter of the disclosure is particularly pointed out and distinctly claimed in the claims at the conclusion of the specification. The forgoing and other features, and advantages of the disclosure are apparent from the following detailed description taken in conjunction with the accompanying drawings in which:

FIG. 1 illustrates a system for pruning a value driver tree according to one embodiment of the present invention;

FIG. 2A illustrates an example of a value driver tree according to an embodiment of the invention;

FIG. 2B illustrates an example of a pruned value driver tree according to an embodiment of the invention;

FIG. 3 illustrates a flowchart of a method for pruning a value driver tree according to an embodiment of the invention;

FIG. 4 illustrates a computer system according to one embodiment; and

FIG. 5 illustrates a computer program product according to one embodiment of the invention.

### DETAILED DESCRIPTION

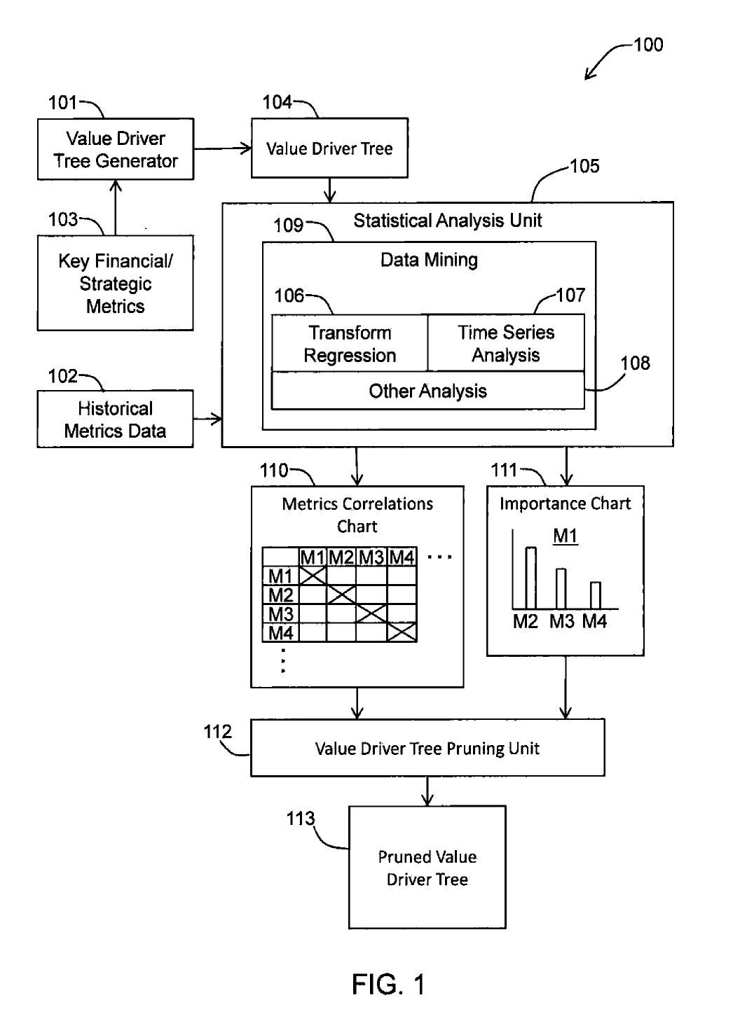

FIG. 1 illustrates a system 100 for pruning a value driver tree according to one embodiment of the invention. The system 100 includes a value driver tree generator 101 configured to generate a value driver tree 104. The value driver tree 104 may include one or more top-level metrics determined to be important or of value to a party, such as a provider, a client, a system, an organization, or any other entity. For example, in one embodiment, the value driver tree 104 is created by a provider of a good or service to analyze a value of an offering of the good or service to a consumer of the good or service. The value driver tree 104 also includes one or more low-level metrics corresponding to each top-level metric. The one or more low-level metrics may be values that are measurable based on real world systems, people, devices, or any other measurable thing or process. The low-level metrics are associated with higher level metrics, such that the measured or measurable values corresponding to the low-level metrics influence the values associated with the higher level metrics.

In the present specification and claims, the term “top-level metrics” describes a metric located at a top-most level of the value driver tree 104, “low-level metrics” describes any metric lower than the top-most level metric of the value driver tree 104 and “bottom-level metrics” describes metrics at the bottom-most level of the value driver tree 104. In addition, the term “parent metric” refers to any metric located above another metric, referred to as a “child metric,” of the value driver tree 104. Each parent metric, also referred to as an upper-level metric, may be a child of another metric, and each child metric, also referred to as a lower-level metric, may be the parent of another metric. In other words, the term “parent” and “child” refer to relationships between any two or more metrics.

In one embodiment, the value driver tree 104 corresponds to an information technology (IT) service offering. In other words, a service provider may formulate an offering or management plan to run IT functions of a client. In such an embodiment, the value driver tree may include top-level metrics associated with a value of the offering to the provider and the client, and low-level metrics associated with the top-level metrics. Examples of top-level metrics may include value to the client, viability, profitability, standardness, competitiveness, innovativeness, completeness, compliance, risk managed and flexibility. While these top-level metrics are provided by way of example, embodiments of the invention encompass the use of any top-level metric.

“Value to the client” may refer to a determination of whether the offering by the provider would address the current and imminent business concerns of the client. An example of a low-level metric associated with providing value to the client may include a number of stated business concerns of the client that are addressed by the offering of the good or service by the provider. “Viability” may refer to whether the provider is capable of providing the proposed solution. An example of a low-level metric that may be associated with the viability of an offering of a good or service may be the percentage of components of the offering that are standard that the provider has a history or known capability for providing.

“Profitability” may refer to whether the provider can provide the offering while maintaining a profit. An example of a low-level metric that may be associated with profitability is a price of the offering, which may include a long-term cost, and revenue generated by the offering. “Standardness” may refer to the extent to which the offering fits within the standard offerings, services and bundles generally provided by the provider. High standardness may correspond to a high quality product and lower costs, since standard products would tend to be replicable by the provider, have fewer unknowns and have known costs. An example of a low-level metric associated with standardness is the number of components, or the percentage of components, of the offering that are recognized as standard components provided by the provider.

“Competitiveness” may refer to the comparability of the bid to provide the service or product to the client with the bids of competitors. An example of a low-level metric associated with the competitiveness of the offering may be the variation of the bid of the provider from comparable bids of competitors or comparable past bids of the provider. “Innovativeness” may refer to innovations suggested by the provider in fulfillment of the goods or services provided Innovations that are aligned with client interests may provide distinct advantages in obtaining a client's business. An example of a low-level metric associated with innovativeness may be the number of components of the offering recognized as being innovative relative to past offerings or comparable offerings.

“Completeness” may correspond to a degree to which the client would like the provider to provide the good or service. For example, if a client has multiple data centers or multiple IT systems, the client may prefer to have a provider take over or provide goods or services to all of the data centers or IT systems. Some providers, however, may prefer to provide goods or services to only a subset of the client's operations to reduce risk. An example of a low-level metric that may be associated with completeness is a percentage of a consumer's demand for a good or service that is fulfilled by the offering. “Compliance” may refer to a degree to which the offering complies with laws or with rules imposed by external groups or from within the provider. An example of a low-level metric that may be used to measure compliance is a fraction of the number of rules with which the offering complies relative to the total number of rules which are known to correspond to the offering.

“Risk managed” may refer to a degree of risk of the offering, taking into account, for example, the strength of existing relationships with the client, the percentage of solutions that are risky or haven't been previously implemented, labor or other third-party involvement or any other factors. “Flexibility” may refer to the degree to which the solution is amenable to changes and upgrades. Examples of low-level metrics associated with “flexibility” may include the duration of a service, the relative upgradability of a good or service relative to other goods or services, the relative ability to transfer personnel into or out of an operation or any other low-level metric providing information regarding a flexibility of the offering.

In embodiments of the invention, the top-level metrics are not, by themselves, readily measured. For example, a good or service does not have a component or rating called “flexibility” that can be referred to by a provider to determine the flexibility of the offering of the provider. Instead, each high-level metric is associated with low-level metrics which are measurable and may provide a basis for setting a value for the top-level metric “flexibility.”

The above high-level metrics are provided by way of example, and embodiments of the invention may include any high-level metric defined by a provider of a good or service, a consumer of a good or service or any other party.

Metrics may be measured in any manner, and the manner in which the metric is measured may depend upon the metric. For example, metrics that provide numerical values may be converted and scaled to a predetermined scale, such as the scale of 1 to 5, 1 to 10, 1 to 100, A to F or any other scale. Similarly, metrics that provide percentage values may be similarly scaled. The values of the metrics may be combined by any formula, such as summing or averaging, to generate a value for the high-level metrics associated with the low-level metrics. The values of the high-level metrics may then be combined in any manner to establish the total value of the offering.

In one embodiment, the value driver tree 104 is generated based on the inputs or programming of experts based on the experience of the experts. In other words, the value driver tree generator 101 may generate the value driver tree 104 based on the inputs of experts to the value driver tree generator 101 or based on a program generated based on assumptions provided by experts.

In embodiments of the invention, historical metrics data 102 and key financial and strategic metrics 103 are provided to a statistical analysis unit 105 to perform a statistical analysis on the historical metrics data 102. The metrics of the historical metrics data 102 correspond to the low-level metrics of the value driver tree 104, or metrics on the value driver tree 104 located below the top-most metrics. The historical metrics data 102 may be obtained from previous transactions of the client or provider, based on characteristic data of existing goods or services or any other historical metrics data 102.

The statistical analysis unit 105 may provide any type of statistical analysis including a transform regression analysis 106, time series analysis 107 or any other statistical analysis 108. In one embodiment, a transform regression 106 is used to account for the presence of complex non-linear relationships among the low-level metrics which makes it difficult to accurately analyze the historical metrics data 102 using linear regression techniques. Since correlations that may exist among low-level metrics may inflate or deflate the impact of changes of the low-level metrics on the high-level metrics, the transform regression 106 may be augmented with a causal modeling technique based on a particular simple subclass of Bayesian networks called dependency trees. The weights or the impact of a lower level metric on a higher level metric, or a child metric on a parent metric, may be obtained by performing random perturbations for each variable using the regression model. Therefore, the derived weight corresponding to the feature importance score of the metric reflects the expected incremental change in the higher level metric, or the parent metric, due to the random perturbation in the lower level metric, or the child metric.

The statistical analysis unit 105 determines the correlation between the child metrics and the parent metrics based on the statistical analysis and by data mining 109 the historical metrics data 102. For example, the statistical analysis unit 105 may generate an array 110, also referred to as a matrix or a metrics correlations chart, containing correlations between each metric and every other metric in a value driver tree 104. In other words, the statistical analysis unit 105 determines an effect each metric has on its peers. This, in essence, translates to how a child metric can influence its parent metric since this array 110, or matrix 110, contains all combinations of metrics correlations. It is noted that although only metrics M1-M4 are listed in the chart of FIG. 1, this is for purposes of illustration only, and the array 110 may include each metric of a value driver tree 104.

In addition, the statistical analysis unit 105 may determine which low-level or child metrics have the greatest influences on each higher-level metric or parent metric or are the most important metrics for determining the value of the parent metric. FIG. 1 illustrates a chart 111 illustrating an importance of the metrics M2, M3 and M4 on the metric M1. In the chart 111 illustrated in FIG. 1, it is determined that M2 has the greatest level of influence on the value of the parent metric M1, M3 has the next greatest level of influence, and M4 has the next greatest level of influence.

The data from the statistical analysis are provided to a value driver tree pruning unit 112. The value driver tree pruning unit 112 prunes the value driver tree 104 based on the statistical analysis of the historical metrics data 102 to generate a pruned value driver tree 113. The value driver tree pruning unit 112 prunes the value driver tree 104 by adjusting the positions, locations or relationships between the metrics in the network of metrics. In one embodiment, the weight or value associated with each metric is compared to a predetermined threshold level representing the minimum level of influence of the child metric on the parent metric. If the weights or values of the metrics fall below the threshold, the metrics are removed from the value driver tree 104.

In another embodiment, a predetermined number of metrics may be permitted to be associated with each high-level metric. For example, in one embodiment, only the three child metrics having the greatest influence on a parent metric may be associated with the parent metric on the value driver tree. In the example of the chart 111 in FIG. 1, the child metrics M2, M3 and M4 would be permitted to be associated with the parent metric M1 on the pruned value driver tree 113, and any metric having an influence on the metric M1 less than the metric M4 would be omitted from the pruned value driver tree 113, or would not be a child metric of the metric M1 on the pruned value driver tree 113. The value driver tree pruning unit 112 may associate one or more low-level metrics with top-level metrics on the value driver tree 104, may remove one or more metrics from the value driver tree 104 altogether, may change an association of one or more child metrics from one parent metric to another, or may perform any other pruning or adjustment based on the statistical analysis of the historical metrics data 102.

By generating a value driver tree 104, the provider of goods or services or any other person, organization or system may analyze a value of an offering of the good or service to a client or other person or organization by associating measurable child metrics with parent metrics that describe different valuable components of an offering. By performing a statistical analysis on historical metrics data 102, the metrics values of the value driver tree 104, which are typically based on experience of experts or other estimates, are refined to more accurately reflect true values of the metrics. By pruning the value driver tree 104 to form the pruned value driver tree 113, less important or less influential metrics are adjusted or eliminated to provide clearer and more accurate values for the parent metrics and clearer and more accurate analysis of the value of the goods or services being analyzed.

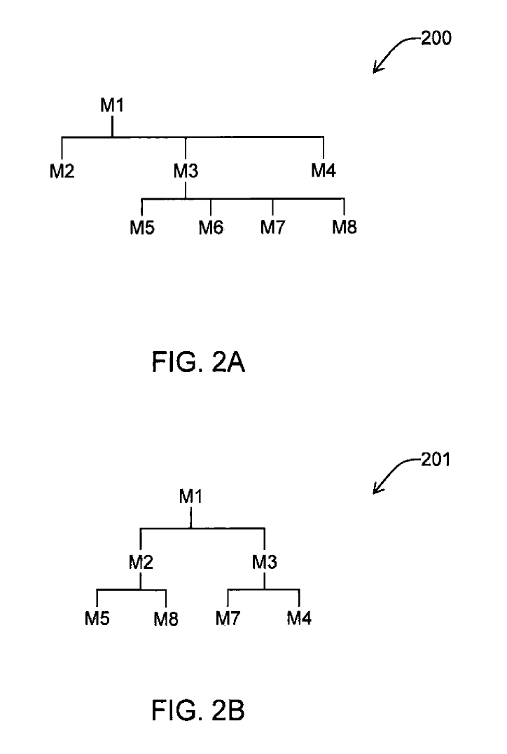

FIGS. 2A and 2B illustrate examples of a value driver tree 200 and pruned value driver tree 201 according to embodiments of the invention.

The value driver tree 200 includes a top-level metric M1, and low-level metrics M2 to M8. While only one top-level metric M1 is illustrated in FIG. 2A, embodiments of the invention encompass value driver trees including any number of top-level metrics, and the low-level metrics may influence one or more of the top level metrics. Metric M1 is considered a parent metric of metrics M2 to M8 (which are, in turn, child metrics of metric M1) and metric M3 is considered a parent metric of metrics M5 to M8 (which are, in turn, child metrics of metric M3). The value driver tree 200 of FIG. 2A represents an initial value driver tree prior to pruning.

FIG. 2B illustrates a pruned value driver tree 201. Based on a statistical analysis of historical metric data of metrics M1 to M8, it is determined that the influence of metric M6 on any other metric is less than a predetermined threshold, so the metric M6 is omitted from the pruned value driver tree 201. In addition, it is determined that metrics M5 and M8 influence metric M2, and metrics M4, M5 and M7 influence metric M3. In addition, it may be determined that metric M8 is not one of the three most-influential metrics on metric M3, so metric M8 may be removed from its parent-child relationship from metric M3. Alternatively, it may be determined that the influence of metric M8 on the metric M3 falls below a predetermined threshold, so the parent-child relationship is omitted from the pruned value driver tree 201.

FIGS. 2A and 2B are provided only as examples of value driver trees, and embodiments of the invention encompass value driver trees including any number of top-most metrics, any number of total metrics, any number of tiers, any number of child metrics per parent metric, or having any other tree structure.

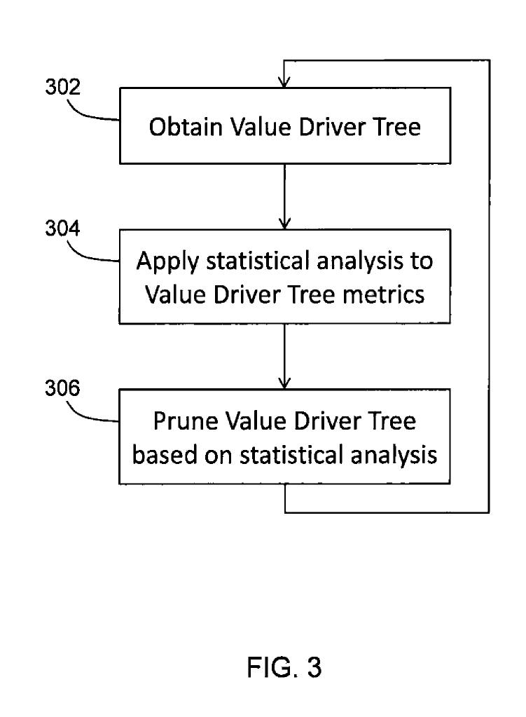

FIG. 3 illustrates a flow diagram of a method for pruning a value driver tree according to one embodiment of the invention. In block 302, a value driver tree is obtained. The value driver tree may be generated, for example, by or on behalf of a provider of a good or service to provide a value of an offering of the good or service for the provider. The value driver tree may include one or more top-level metrics determined to be important or of value to a party, such as to the provider of the good or service and the recipient of the good or service. The value driver tree also includes one or more low-level metrics corresponding to each high-level metric. The one or more low-level metrics may be values that are measurable based on real world systems, people, devices, or any other measurable thing or process. The low-level metrics are associated with higher level metrics, such that the measured or measurable values corresponding to the low-level metrics influence the values associated with the higher level metrics.

The value driver tree may be generated by a computer, or by a processor running a computer program that receives as inputs top-level metrics and low-level metrics that are either pre-defined or supplied by experts based on the experience of the experts.

In block 304, a statistical analysis is applied to historical metrics data, where the metrics correspond to the metrics of the value driver tree. The statistical analysis may be any type of statistical analysis including a transform regression analysis, time series analysis or any other statistical analysis.

The statistical analysis determines the correlation between the low-level metrics, or child metrics, and the higher-level metrics, or parent metrics. In addition, the statistical analysis generates information regarding which child metrics have the greatest influences on each parent metric or are the most important child metrics for determining a value of the parent metrics.

In block 306, the data from the statistical analysis of the historical metrics data are used to prune the value driver tree to generate a pruned value driver tree. Pruning the value driver tree may include associating one or more new child metrics with parent metrics on the value driver tree, removing one or more low-level metrics from the value driver tree altogether, changing the association of one or more child metrics from one parent metric to another, or performing any other pruning or adjustment based on the statistical analysis of the historical metrics data.

Over time, as business conditions change and influencing factors of one metric over another change, the value driver tree, and the pruned value driver tree may need further pruning to meet current business needs. Accordingly, FIG. 3 illustrates an arrow from block 306 to block 302 to illustrate that an entity may update the value driver tree at regular intervals over time to accommodate changing priorities and changing business conditions.

While embodiments of the present invention encompass pruning value driver trees associated with any field or endeavor, in one embodiment, the value driver tree corresponds to an offering of an information technology (IT) service provider to provide IT services to a consumer.

For example, a consumer may request bids to have IT service providers begin or take over IT services of the consumer, including maintaining servers, managing software and data flow, and any other IT services. In some embodiments, the customer or client is a person, company, organization, agency, government or any other entity. The IT providers may analyze the requirements of the consumer and provide bids to the consumer. The value driver trees may be used to determine the values of the bids generated. Top-level metrics, such as value to the client, viability, profitability, standardness, competitiveness, innovativeness, completeness, compliance, risk managed and flexibility may be applied to the IT offering and low-level metrics may be generated based on each top-level metric to provide values corresponding to the top-level metrics. The values of the top-level metrics may be combined by any algorithm to provide a value of the IT services offering.

IT services historical data corresponding to the metrics may be gathered, such as by analyzing previous or comparable IT services contracts, jobs or operations. The historical data corresponding to the metrics are analyzed with a statistical analysis to determine the correspondence between each low-level metric and each top-level metric, as well as between each child metric and each parent metric, and the value driver tree is pruned based on the statistical analysis to improve the accuracy of the value estimate to one or both of the provider and the consumer.

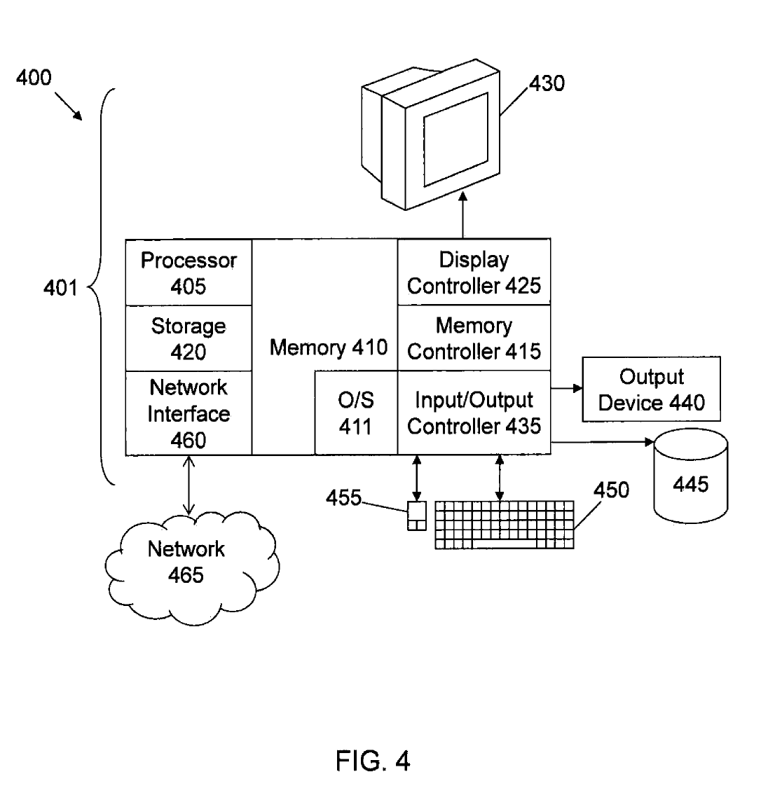

FIG. 4 illustrates a block diagram of a computer system 400 according to an embodiment of the present disclosure. The methods described herein can be implemented in hardware, software (e.g., firmware), or a combination thereof. In an exemplary embodiment, the methods described herein are implemented in hardware as part of the microprocessor of a special or general-purpose digital computer, such as a personal computer, workstation, minicomputer, or mainframe computer. The system 400 therefore may include general-purpose computer or mainframe 401.

In an exemplary embodiment, in terms of hardware architecture, as shown in FIG. 4, the computer 401 includes one or more processors 405, memory 410 coupled to a memory controller 415, and one or more input and/or output (I/O) devices 440, 445 (or peripherals) that are communicatively coupled via a local input/output controller 435. The input/output controller 435 can be, for example, one or more buses or other wired or wireless connections, as is known in the art. The input/output controller 435 may have additional elements, which are omitted for simplicity in description, such as controllers, buffers (caches), drivers, repeaters, and receivers, to enable communications. Further, the local interface may include address, control, and/or data connections to enable appropriate communications among the aforementioned components. The input/output controller 435 may access the output devices 440 and 445.

The processor 405 is a hardware device for executing software, particularly that stored in storage 420, such as cache storage, or memory 410. The processor 405 can be any custom made or commercially available processor, a central processing unit (CPU), an auxiliary processor among several processors associated with the computer 401, a semiconductor based microprocessor (in the form of a microchip or chip set), a macroprocessor, or generally any device for executing instructions.

The memory 410 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, and/or other types of storage media. Note that the memory 410 can have a distributed architecture, where various components are situated remotely from one another, but can be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (O/S) 411. The operating system 411 essentially controls the execution of other computer programs and provides scheduling, input-output control, file and data management, memory management, and communication control and related services.

In an exemplary embodiment, a conventional keyboard 450 and mouse 455 can be coupled to the input/output controller 435. Other output devices such as the I/O devices 440, 445 may include input devices, for example, but not limited to a printer, a scanner, microphone, and the like. Finally, the I/O devices 440, 445 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 400 can further include a display controller 425 coupled to a display 430. In an exemplary embodiment, the system 400 can further include a network interface 460 for coupling to a network 465. The network 465 can be any type of network, such as an IP-based network for communication between the computer 401 and any external server, client and the like via a broadband connection, an optical fiber network, or any other type of network.

The network 465 transmits and receives data between the computer 401 and external systems. In an exemplary embodiment, network 465 can be a managed IP network administered by a service provider. The network 465 may be implemented in a wireless fashion, e.g., using wireless protocols and technologies, such as WiFi, WiMax, etc. The network 465 can also be a packet-switched network such as a local area network, wide area network, metropolitan area network, Internet network, or other similar type of network environment. The network 465 may be a fixed wireless network, a wireless local area network (LAN), a wireless wide area network (WAN) a personal area network (PAN), a virtual private network (VPN), intranet or other suitable network system and includes equipment for receiving and transmitting signals.

When the computer 401 is in operation, the processor 405 is configured to execute instructions stored within the memory 410, to communicate data to and from the memory 410, and to generally control operations of the computer 401 pursuant to the instructions.

In an exemplary embodiment, the methods of managing memory described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

In embodiments of the present disclosure, the value driver tree pruning may utilize hardware and software within the computer system 400, including memory 410 or output devices 440 and 445 for storing value driver trees, metrics, and historical metrics data. The processor 405 may perform statistical analysis and the display controller 425 may generate a display of a value driver tree.

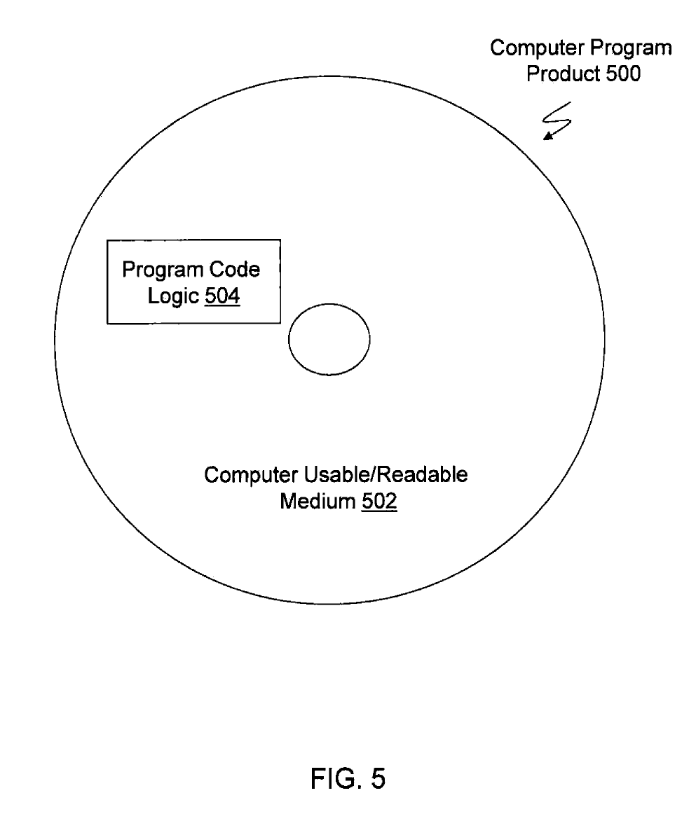

As described above, embodiments can be embodied in the form of computer-implemented processes and apparatuses for practicing those processes. An embodiment may include a computer program product 500 as depicted in FIG. 5 on a computer readable/usable medium 502 with computer program code logic 504 containing instructions embodied in tangible media as an article of manufacture. Exemplary articles of manufacture for computer readable/usable medium 502 may include floppy diskettes, CD-ROMs, hard drives, universal serial bus (USB) flash drives, or any other computer-readable storage medium, wherein, when the computer program code logic 504 is loaded into and executed by a computer, the computer becomes an apparatus for practicing the embodiments. Embodiments include computer program code logic 504, for example, whether stored in a storage medium, loaded into and/or executed by a computer, or transmitted over some transmission medium, such as over electrical wiring or cabling, through fiber optics, or via electromagnetic radiation, wherein, when the computer program code logic 504 is loaded into and executed by a computer, the computer becomes an apparatus for practicing the embodiments. When implemented on a general-purpose microprocessor, the computer program code logic 504 segments configure the microprocessor to create specific logic circuits.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention to the particular embodiments described. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosed embodiments. Many modifications and variations will be apparent to those of ordinary skill in the art without departing from the scope and spirit of the embodiments of the present disclosure.

In embodiments of the present disclosure, effects of modifications to standard business processes may be estimated based on stored prior modifications to the standard business processes. In addition, proposed modifications to standard business processes may be provided based on desired effects provided by an entity. Accordingly, past customizations to processes may be utilized to more efficiently design and select future customizations. In addition, guidance may be provided to entities regarding the likely effects of desired changes to processes implemented by the entities. Examples of processes may include business financial or operational processes, software or electrical processes and manufacturing processes. However, it is understood that embodiments of the present disclosure encompass any process that may be represented by data in a graphical form, stored and analyzed.

While preferred embodiments have been described above, it will be understood that those skilled in the art, both now and in the future, may make various improvements and enhancements which fall within the scope of the claims which follow.

1. A method comprising:
obtaining a value driver tree including (i) one or more parent metrics determined to be of interest to a party and (ii) one or more child metrics, the one or more parent metrics used to measure at least one of a value of a company, an organization, a service provider, a service consumer or an individual, and the one or more child metrics used to determine the value of the one or more parent metrics;
performing, with a processing device, a statistical analysis on historical metrics data of the one or more parent metrics and the one or more child metrics; and
pruning the value driver tree based on the statistical analysis by altering the position of the one or more child metrics relative to the one or more parent metrics.

2. The method of claim 1, wherein performing the statistical analysis includes determining the importance of the one or more child metrics to the one or more parent metrics.

3. The method of claim 2, wherein determining the importance of the one or more child metrics to the one or more parent metrics includes determining a relationship between a change in the value associated with the one or more child metrics to a change in the value associated with the one or more parent metrics.

4. The method of claim 1, wherein altering the positions of the one or more child metrics includes removing and/or re-arranging the positions of the one or more child metrics from the value driver tree, based on determining that a change in the one or more child metrics results in a change in the one or more parent metrics being less than a predetermined threshold.

5. The method of claim 1, wherein altering the positions of the one or more child metrics includes changing a correlation on the value driver tree of the one or more child metrics from a first parent metric among the one or more parent metrics to a second parent metric among the one or more parent metrics, based on determining that (i) the importance of the one or more child metrics to the one or more parent metrics falls below a predetermined threshold and (ii) the importance of the one or more child metrics to the second parent metric is above the predetermined threshold.

6. The method of claim 1, wherein the value driver tree includes a plurality of parent metrics and a plurality of child metrics, and
performing the statistical analysis includes determining an effect of a change in each of the plurality of child metrics on each of the plurality of parent metrics.

7. The method of claim 6, wherein pruning the value driver tree includes determining which child metrics among the one or more child metrics have the greatest influence on a parent metric among the one or more parent metrics, and associating only the child metrics determined to have the greatest influence on the parent metric with the parent metric on the value driver tree.

8. The method of claim 1, wherein the statistical analysis is a transform regression analysis.

9. The method of claim 1, wherein the value driver tree corresponds to an information technology (IT) solution by an IT service provider to an IT service consumer, and
the method further includes, based on the refined value driver tree, predicting at least one of:
a client's satisfaction, a profitability of the IT service provider, a viability of the IT solution, a standardness of the solution, a competitiveness of the solution, an innovativeness of the solution, a risk of the solution, a flexibility of the solution and a compliance of the solution to a corresponding service level agreement.

10.-16. (canceled)

17. A computer program product for pruning a value driver tree, the computer program product comprising:
a tangible storage medium readable by a processing circuit and configured to store instructions for execution by the processing circuit for performing a method comprising:
obtaining a value driver tree including one or more parent metrics and one or more child metrics, the one or more parent metrics determined to be of value to a party, and the one or more child metrics assumed by a provider of the one or more child metrics to relate to the one or more parent metrics;
performing a statistical analysis on historical metrics data of the one or more child metrics; and
pruning the value driver tree based on the statistical analysis by altering a position relative to the one or more parent metrics of the one or more child metrics.

18. The computer program product of claim 17, wherein performing the statistical analysis includes determining an importance of the one or more child metrics to the one or more parent metrics.

19. The computer program product of claim 18, wherein determining the importance of the one or more child metrics to the one or more parent metrics includes determining a relationship between a change in the one or more child metrics and a change the value associated with the one or more parent metrics.

20. The computer program product of claim 17, wherein altering the position of the one or more child metrics includes removing the one or more child metrics from the value driver tree based on determining that a change in the one or more child metrics results in a change in each of the one or more parent metrics, the change being less than a predetermined threshold.

21. The computer program product of claim 17, wherein altering the position of the one or more child metrics includes changing a correlation on the value driver tree of the one or more child metrics from a first parent metric among the one or more parent metrics to a second parent metric among the one or more parent metrics based on determining that an importance of the one or more child metrics to the first parent metric falls below a predetermined threshold and the importance of the one or more child metrics to the second parent metric is above the predetermined threshold.

22. The computer program product of claim 17, wherein the value driver tree includes a plurality of parent metrics and a plurality of child metrics, and
performing the statistical analysis includes determining an effect of a change in each of the plurality of child metrics on each of the plurality of parent metrics.

23. The computer program product of claim 17, wherein the statistical analysis is a regression transform analysis.

24. The computer program product of claim 17, wherein the value driver tree corresponds to an information technology (IT) solution by an IT service provider to an IT service consumer, and
the method further includes, based on the refined value driver tree, predicting at least one of:
a client's satisfaction, a profitability of the IT service provider, a viability of the IT solution, a standardness of the solution, a competitiveness of the solution, a risk of the solution, a flexibility of the solution and a compliance of the solution to a corresponding service level agreement.

25. A method, comprising:
pruning a value driver tree (VDT) to generate a pruned VDT, wherein pruning the VDT includes performing at least one of (i) omitting a first metric of the VDT from the pruned VDT and (ii) changing a dependency of the first metric from a second metric in the pruned VDT based on conducting a statistical analysis on historical metrics data of each metric of the VDT; and
using the pruned VDT to assess the quality of a service provided by a company, an organization, a service provider, a service consumer and/or an individual.
